(19) United States
(12) Patent Application Publication
(10) Pub. No.: US 2014/0214994 A1
(43) Pub. Date: Jul. 31, 2014

(54) SYSTEM AND METHOD FOR DETERMINING A PREFERRED COMMUNICATION CHANNEL

(71) Applicants: TOBIAS RUECKERT, WINTERBACK (DE); MARKUS LEHNERT, FRANKFURT (DE)

(72) Inventors: TOBIAS RUECKERT, WINTERBACK (DE); MARKUS LEHNERT, FRANKFURT (DE)

(21) Appl. No.: 14/251,733

(22) Filed: Apr. 14, 2014

Related U.S. Application Data
(63) Continuation-in-part of application No. PCT/EP2012/004424, filed on Oct. 23, 2012.

(30) Foreign Application Priority Data
Nov. 1, 2011 (DE) 10 2011 117 777.2

(51) Int. Cl. H04L 12/58

(52) U.S. Cl. CPC H04L 51/36
USPC 709/206

(57) ABSTRACT

The invention relates to a system (14) and a method for determining a preferred communication channel for the delivery of an electronic message from a sender (10) to a recipient (12). The system comprises an input module (15), via which a request, from a requesting system (11), for a preferred communication channel can be received. Further it comprises a selection module (16), by which a first probability of availability of the recipient (12) can be estimated via a first communication channel (13a) and a second probability of availability via a second communication channel (13b). Selection module (16) determines the preferred communication channel depending on the first and second probability of availability, which thereupon is output to requesting system (11) by an output module (18). In determining the preferred communication channel, a confidentiality level of the confidentiality of the electronic message is considered.

### CROSS-REFERENCE TO RELATED APPLICATION

This is a continuation-in-part application of pending international application PCT/EP2012/004424 filed Oct. 23, 2012 and claiming the priority of German Application No. 10 2011 117 777.2 filed Nov. 1, 2011 which is hereby incorporated herein by reference in its entirety as though fully set forth.

### BACKGROUND OF THE INVENTION

The invention relates to a system for determining a preferred communication channel for delivery of an electronic message from a sender to a recipient with the features of claim 1 and a method of determining a preferred communication channel for delivery of an electronic message from a sender to a recipient with the features of claim 9.

In U.S. Pat. No. 7,966,373 B1, a system for delivery of an electronic message to a recipient is described. The system can send electronic messages by different communication channels. The system comprises a database, in which so called profiles of different recipients can be stored. Stored in these profiles is, for example, the time at which an electronic message is to be sent to the recipient by what communication channel. The profiles can be set, for example, by the recipient.

In WO 2007/113516 A1, a system for determining a preferred communication channel for delivery of an electronic message from a sender to a recipient is described. For this purpose, the system estimates a probability of availability of the recipient for different communication channels and selects as preferred communication channel the communication channel with the highest probability of the availability of the recipient.

US 2004/0249776 A1 and US 2007/0071209 A1 describe systems for determining a preferred communication channel for delivery of an electronic message from a sender to a recipient. These systems comprise models for forecasting the availability of the recipient. Based on the results of these models, the systems select a preferred communication channel by which the message reaches the recipient with high probability.

US 2008/0019285 A1 also describes such a system. The system includes a so called availability manager which estimates the availability of the recipient by different communication channels on the basis of rules or functions. Based on this estimate, the system selects the preferred communication channel.

US 2003/0154293 A1 also describes such a system. The system gathers information on the utilization of different communication channels by the recipient. On the basis of this information the system selects the preferred communication channel.

Compared with this, it is the object of the invention to provide a system and a method by which a communication channel can be determined by which the recipient can be reached promptly with high probability while preserving the confidentiality required for the delivery of an electronic message. This objective is accomplished, according to the present invention, by a system with the features of claim 1 and a method with the features of claim 9.

### SUMMARY OF THE INVENTION

The invention provides a system (14) and a method for determining a preferred communication channel for the delivery of an electronic message from a sender (10) to a recipient (12). The system comprises an input module (15), via which a request, from a requesting system (11), for a preferred communication channel can be received. Further it comprises a selection module (16), by means of which, for example, a first probability of availability of the recipient (12) can be estimated via a first communication channel (13a) and a second probability of availability via a second communication channel (13b). Selection module (16) determines the preferred communication channel (13a) or channel (13b) depending on the first and second probability of availability, which thereupon is output to requesting system (11) by an output module (18). In determining the preferred communication channel (13a) or channel (13b), a confidentiality level of the confidentiality of the electronic message is considered.

The system comprises an input module via which a request from a requesting system for a preferred communication channel can be received from the sender to the recipient. The requesting system is executed, in particular, as an electronic communication system of the sender which can deliver electronic messages by different communication systems, for example, by using the internet. The requesting system can, for example, be executed as a system for editing electronic messages according to the German patent application DE 10 2009 022 764 A1. Usable as communication channels are all present and future communication channels by which electronic messages can be delivered. The communication channels can be executed, for example, as e-mail, SMS (Short Message Service), social networks such as, for example, Facebook®, Linkedln®, short message services such as, for example, Twitter®, or a so called Instant Messaging System such as, for example, Skype®. Likewise it is possible that text messages are read out via telephone or converted into a conventional paper letter or converted from a paper letter into an electronic message.

The system to which the invention relates also includes an interface module with at least a first interface to a first communication channel and a second interface to a second communication channel to the recipient. The interface module can, in particular, also could comprise more than two interfaces each to respective communication channels. The communication channels served by the interface module should at least partly cover the communication channels utilized by the requesting system as otherwise no usable preferred communication channel can be determined.

Furthermore, the system to which the invention relates comprises a selection module by which a first probability of availability of the recipient of the electronic message can be estimated via the first communication channel and a second probability of availability via the second communication channel.

The objective of the selection module is to first determine the preferred communication channel as a function of the first and second probabilities of availability. The communication channel with the higher probability of availability, in particular, is provisionally selected as the preferred communication channel. For this, it is not necessary that an absolute value of the probability of availability be determined; the finding that the probability of availability of one communication channel is higher than that of the other communication channel suffices to provisionally determine the preferred communication channel.

According to the invention, the objective of the selection module is in determining the preferred communication channel to consider a confidentiality level characterizing the confidentiality of the electronic message. The confidentiality level can be specified by the sender. Examples of confidentiality levels are “private”, “group-internal”, “public” and “no restriction”. In the case of the confidentiality level “private”, for example, the selection module selects only from communication channels from which the recipient alone can retrieve messages, for example, a personally assigned e-mail account or a personal message in a social network. On the “group-internal” confidentiality level, the message can also be delivered to an e-mail account assigned to a group or a team or to other available team members defined in a mailing list. In case of the “public” confidentiality level, only public communication channels such as, for example, social networks, are considered. On the “no restriction” confidentiality level, the selection module selects from all available communication channels. Another confidentiality level, for example “public only”, can also be determined by which it can be selected that the recipient can only reply publicly to an electronic message.

In particular, more than two communication channels can be considered. This makes it possible, in particular, that not only one preferred communication channel but a list of communication channels sorted by the probability of availability is determined and is output if requested by the requesting system.

If a sender intends sending an electronic message to more than one recipient, at first, a preferred communication channel is determined separately for every recipient. If the same preferred communication channel is returned for all recipients, that channel is determined as the preferred communication channel for all recipients. If the preferred communication channels to the different recipients are different, this can be communicated to the sender and the communication channels to be used can be selected by the sender. It is also possible that the sender defines presets for that event which will then be considered automatically for sending the message to the different recipients.

The selection module determines the probability of availability of the recipient via a communication channel, in particular, in dependence on a first time duration since the last use of this communication channel by the recipient. Use of the communication channel, in this connection, means, in particular, the sending of an electronic message by the recipient or the reading or retrieving of an electronic message by the recipient by that communication channel. This is possible, in particular, when the recipient also uses the system according to the invention for sending and/or receiving electronic messages. The selection module, for determining the said first time duration, can, for example, revert to an electronic communication system used by the recipient for sending electronic messages and retrieve from that communication system the data necessary for determining the first time duration. It is also possible that the selection module logs, in particular, the point in time, the addressee and the communication channel during sending electronic messages of the recipient and determines the said first time duration from that log.

For estimating the said probability of availability, in particular, only electronic messages from the recipient to the sender can be considered. However, the sending of electronic messages on that communication channel by the recipient to addressees other than the sender can also be used. The probability of availability for that communication channel is higher the shorter the said first time duration is. The probability of availability can, for example, be estimated as the reciprocal value of the first time duration in units of seconds. By considering the said first time duration, the probability of availability can be estimated rather exactly. For example, if the recipient has sent an electronic message to the sender or another addressee by the communication channel in question, for example, 60 seconds ago, the chance and therefore the probability of availability to reach him by that communication channel is very high. On the other hand, if the recipient has not sent or read an electronic message by that communication channel for hours, the probability of availability for that communication channel is very low.

The selection module can also be chosen for polling an activity status of the recipient on a communication channel and estimating the probability of availability of the recipient by that communication channel in dependence on the polled activity status. In different social networks an activity status is set either by activities of the respective user in the social network or by the users themselves. That activity status indicates, for example, whether the user is on-line or off-line, whether despite being on-line they are busy at present, whether they are online but do not want to be disturbed at the moment or whether they are on-line and ready for communication. That activity status can also be polled in the social network. For that purpose, the recipient may have to make their access data to the appropriate communication channel or social network available to the system according to the invention. The activity statuses of the different communication channels can be different so that a high probability of availability can be assigned to the communication channel by which the recipient indicates by the associated activity status that they are available.

A particularly exact definition of the probability of availability is obtained when for determining the probability of availability of the recipient on a communication channel a change of the activity status of the recipients on that communication channel is considered. In particular, a second time duration since a change of an activity status that indicates non-availability is determined for an activity status that indicates availability. That time duration can be polled in the respective communication system or social network. However, it is also possible that the selection module cyclically polls the activity status of the recipient on the different communication channels, records a change of the activity status and logs the time of the change. Thereupon, the said second time duration can be determined by means of that log. The probability of availability of a communication channel is the higher the shorter the said second time duration is. The probability of availability can, for example, be determined as reciprocal value of the second time duration in seconds.

By determining the said second time duration it is possible advantageously to estimate, for the communication channels, availability probabilities that are comparable with each other, irrespective of whether or not activity statuses can be polled on the different communication channels.

It is also possible that the interface module comprises an interface to an electronic calendar of the recipient. The electronic calendar can, for example, be managed by a server that can be accessed via the internet. The selection module can use information stored in the electronic calendar to estimate probabilities of availability of different communication channels.

The system according to the invention includes, in particular, an output module by which the preferred communication channel can be output to the requesting system. Accordingly, the system according to the invention can be executed entirely independent of the requesting system.

In embodying the invention, the object of the input module is also to accept the content of the electronic message. The content is, in particular, transmitted in encrypted form by the requesting system to the input module. Provided, in addition, as a component of the interface module, is a transmission module by which the electronic message can be transmitted to the recipient via the preferred communication channel. So the requesting system which the user uses for sending electronic messages can be of simpler design because only one interface of the system according to the invention is needed for sending electronic messages.

In embodying the invention, the system according to the invention can include a generating module by which an electronic message can be generated and which can take over the function of the requesting system. Therefore, the user needs only one system for sending electronic messages and consequently no interfaces are needed between different systems.

In embodying the invention, the system according to the invention can include a configuration module by means of which the recipient can set the behavior of the system. It can define, in particular, for which communication channels a probability of availability should be estimated and/or which requesting systems can make a request for a preferred communication channel and/or for what sender requesting systems can make a request for a preferred communication channel and/or how the preferred communication channel shall be determined from the individual probabilities of availability of the different communication channels. This allows the recipient to adapt the behavior of the system according to the invention to his needs.

For example, the recipient can define which communication channel is selected as the preferred communication channel if several communication channels have the same probability of availability. They can also define whether in the case in which the highest probability of availability is lower than the threshold value always a certain communication channel such as, for example SMS or e-mail, is selected as the preferred communication channel.

In embodying the invention, the system according to the invention can include a status module by means of which the recipient can define, for one or several communication channels, a status that is typical of them, which can then be transmitted to the sender. The status can, for example, be equal to the activity status referred to above. It is also possible that other statuses can be defined instead of or in addition to the activity status. For example, information about the whereabouts of the recipient, their current activity, etc. can be defined and transmitted to the sender. Moreover, information on the emotional state of the recipient such as, for example, “I am tired”, “I am happy”, etc., can be defined and transmitted. These further items of information can either be entered by the recipient or generated automatically. Information on the whereabouts can be generated by a GPS (Global Positioning System) and transmitted to the status module. It is also possible that information on the whereabouts is determined by means of IP tracking. This means that the present whereabouts of the recipient are determined via the IP address of the computer by which the recipient is linked to the internet. The emotional status can be transmitted by a separate system by considering the determining, for example, heart rate, blood pressure, etc. and transmitted to the status module. These different statuses can be considered by the selection module when determining the preferred communication channel.

While doing so, the said statuses of the recipient cannot only be transmitted to the sender. It is also possible that the statuses are transmitted, via the interface module, to the different communication channels, in particular, the different social networks. So the recipient can set their status at a central point and distribute it to several communication channels and social networks, respectively.

The said statuses, in particular, with regard to the present activity or the whereabouts of the recipient, can also be updated automatically by means of information of an electronic calendar linked to the interface module.

The functionality of the status module can also be used, regardless of the determination of a preferred communication channel, for delivery of an electronic message by a sender to a recipient.

### BRIEF DESCRIPTION OF THE DRAWINGS

Further embodiments of the invention are obvious from the description and the figure. Examples of embodiments of the invention are shown in simplified form in the drawings and explained in detail in the following description. In which:

FIG. 1 illustrates a schematic diagram of a system for sending electronic messages by a sender to a recipient,

FIG. 2 is an alternative embodiment of a system for sending electronic messages,

FIG. 3 is another alternative embodiment of a system for sending electronic messages, and

FIG. 4 is a system with a configuration module and a status module by means of which a recipient can determine a status that is characteristic of them.

### DETAILED DESCRIPTION OF THE INVENTION

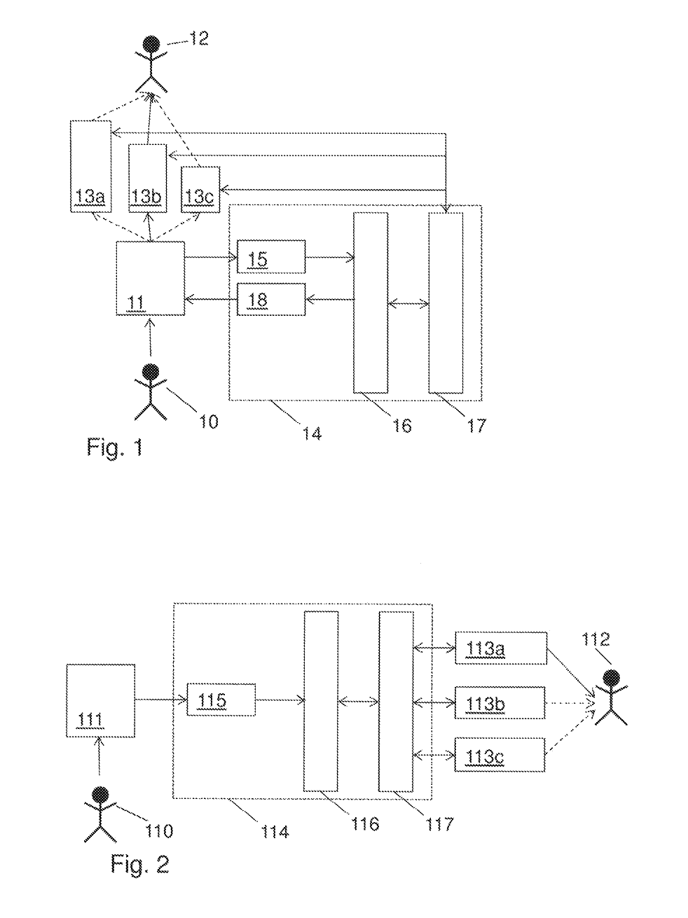

With reference to FIG. 1, a sender 10 can generate, by means of a requesting system 11 that is embodied as an electronic communication system, an electronic message which he wants to send to a recipient 12. In this embodiment, three different communication channels 13a, 13b, 13c, exist between sender 10 and recipient 12, which can be executed, for example, as e-mail, SMS (Short Message Service), social networks such as, for example, Facebook®, Linkedln®, short message services such as, for example, Twitter®, or an instant messaging system such as, for example, Skype®. In this embodiment, communication channel 13a shall be executed as an e-mail account, communication channel 13b as a social network and communication channel 13c as an SMS. In addition to these three communication channels, there can even be more, including more of one type.

Sender 10 would like that the message reaches or is noted by recipient 12 as quickly as possible, it being of no relevance to sender 10 by what communication channel 13a, 13b, 13c the message is transmitted to recipient 12. Therefore, the message is to be sent via that of communication channels 13a, 13b, 13c which recipient 12 will poll with highest probability, the so called probability of availability; recipient 12, therefore, is available. In order to determine the preferred communication channel with the highest probability of availability, requesting system 11 sends a request, via the internet, to system 14 to determine a preferred communication channel for delivery of the electronic message to recipient 12. The request is received via input module 15 and contains mainly information on the identity of recipient 12 and the communication channels 13a, 13b, 13c available for reaching recipient 12. Furthermore, the size of the electronic message and its type (text or graphics only) can also be transmitted. The request is verified by input module 15 to see whether sender 10 is authorized to make such an inquiry and whether recipient 12 is known to system 14. If both conditions are satisfied, input module 15 passes on the request directly to a selection module 16 of system 14 which determines the preferred communication channel. If recipient 12 is not known to the system, input module 15 tries to retrieve further information in the internet, in particular, further possible communication channels to the recipient. In selecting the preferred communication channel all possible communication channels to recipient 12 are then taken into consideration.

Selection module 16, at first, checks which of the available communication channels 13a, 13b, 13c is suitable for transmitting the electronic message. For this purpose, selection module 16 compares the size and type of the electronic message with the possible sizes and types of messages of the individual communication channels stored in system 14. In this example, the electronic message shall be a short text message which could be transferred by all available communication channels 13a, 13b, 13c.

Selection module 16, for determining the preferred communication channel via an interface module 17 of system 14 and the internet, establishes contact with communication channels 13a, 13b, 13c. To this end, recipient 12 has authorized system 14 to poll the required data from communication channels 13a, 13b, 13c. For this purpose, recipient 12 has made available to system 14, for example, the user information and code words required for this.

Selection module 16 inquires from the first communication channel 13a, executed as e-mail account, when recipient 12 sent or read an e-mail last. Starting from the current point in time, selection module 16 determines from that information the time duration since that event and therefore the time duration since the last use of that communication channel 13a. By calculating the reciprocal value of that first time duration, a first probability of availability is calculated for communication channel 13a. For example, this first time duration shall be 2 hours and therefore 7200 seconds, which yields a first probability of availability of approximately 0.000139.

Selection module 16 inquires from the second communication channel 13b, executed as a social network, when the activity status of recipient 12 last changed from an activity status indicating non-availability to an activity status indicating availability. Starting from the current point in time, selection module 16 determines from that information the time duration since that event. By calculating the reciprocal value of that second time duration, a second probability of availability is calculated for communication channel 13b. For example, the second time duration shall be 200 seconds, which yields a second probability of availability of 0.005.

Selection module 16 inquires from the third communication channel 13c, executed as an SMS, when recipient 12 last wrote or read an SMS. Starting from the current point in time, selection module 16 determines from that information the time duration since that event. By calculating the reciprocal value of that second time duration, a third probability of availability is calculated for communication channel 13c. For example, the third time duration shall be 1 hour and therefore 3600 seconds, which yields a third probability of availability of 0.000278.

Selection module 16 compares the three determined availability probabilities with each other and determines the communication channel with the highest probability of availability. In the numerical examples chosen here, communication channel 13b with a probability of availability of 0.005 has the highest probability of availability so that selection module 16 determines the second communication channel 13b as the preferred communication channel.

Selection module 16 passes the information on to an output module 18 of system 14, which thereupon transmits the information via the internet to requesting system 11.

In virtue of the information provided by system 14 on the preferred communication channel 13b, requesting system 11 sends the electronic message of sender 10 to recipient 12 via communication channel 13b in form of a social network. By transmitting the message via that communication channel 13b, the chance that recipient 12 notes the message promptly is highest in comparison with the other communication channels 13a, 13c.

It is also possible that the definition of a probability of availability for the third communication channel 13c in form of the SMS is waived. Selection module 16 can then be executed in such a manner that communication channel 13c is automatically determined as preferred communication channel when the probabilities of availability of the other communication channels 13a, 13b are below a threshold value. The threshold value can, for example, be 0.000278, which corresponds to a time duration of approximately one hour. This means that the electronic message will always be transmitted as SMS by sender 10 to recipient 12 when the recipient has been inactive on the other communication channels for more than one hour. This approach is based upon the conception that even if receiving an SMS may be relatively uncomfortable recipient 12 will note the receipt of an SMS on their cell phones with very high probability.

Instead of waiving the estimation of a probability of availability for the third communication channel 13c in form of an SMS, the estimation of a probability of availability for the first communication channel 13a in form of an e-mail account can also be waived. This is the case when e-mail is used as default communication channel instead of SMS.

Illustrated in FIG. 2 is an embodiment of a system for sending electronic messages alternative to FIG. 1. With reference to FIG. 2, a sender 110 generates an electronic message, by means of a requesting system 111 executed as electronic communication system, that he wants to send to a recipient 112.

For this purpose, requesting system 111 transmits, via the internet, the message content and the information on the identity of recipient 112 to an input module 115 of a system 114 for determining a preferred communication channel for delivery of the electronic message to recipient 112. A selection module 116 of system 114 determines, analogously to selection module 16 in FIG. 1, involving an interface module 117 of system 114, the preferred communication channel, in this case communication channel 113a, which has a higher probability of availability than communication channels 113b and 113c.

In determining the preferred communication channel, the selection module takes into account a confidentiality level characterizing the confidentiality of the electronic message. The confidentiality level is defined by sender 110 and transferred by requesting system 111 to input module 115 together with the other information. The recipient can define one of the confidentiality levels “private”, “group-internal”, “public” and “no restriction”. In case of the confidentiality level “private”, selection module 115 selects only from communication channels that only the recipient can poll, that is, for example, a personally assigned e-mail account or a personal message in a social network. In case of the confidentiality level “group-internal”, the message can also be sent to an e-mail account assigned to a team. In case of the confidentiality level “public”, only public communication channels such as, for example, public news in social networks, are considered. In case of the confidentiality level “no restriction”, selection module 115 selects from all available communication channels. It is also possible that selection module 16 in FIG. 1 takes a confidentiality level into consideration. Interface module 117 is simultaneously also executed as a transmitter module, which can transmit electronic messages. After selecting the preferred communication channel 113a, interface module 117 transmits the electronic message via communication channel 113a to recipient 112.

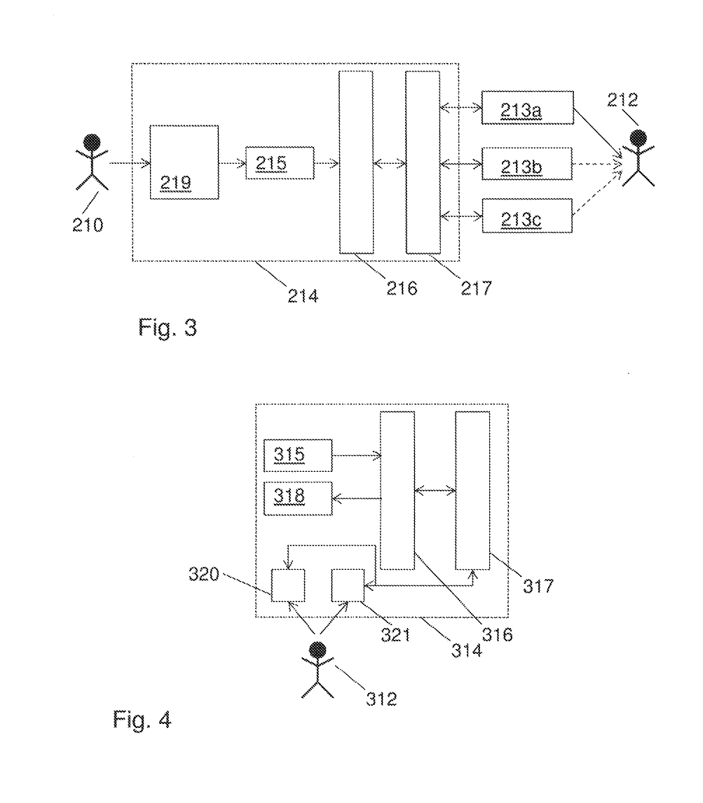

Illustrated in FIG. 3 is an embodiment of a system for sending electronic messages alternative to FIG. 2. This embodiment differs from the embodiment in FIG. 2 only in that a system 214 for determining a preferred communication channel for delivery of an electronic message from a sender 210 to a recipient 212 also includes a generating module 219 by means of which sender 210 can generate the electronic message. Generating module 219 then takes over the function of the requesting system in FIGS. 1 and 2 and transfers the message and the information about the identity of recipient 212 to an input module 215.

In that case, the probability of availability for a communication channel in form of an e-mail account can be estimated without access to the e-mail account via the internet. The purpose of system 214, in that case, is, in particular, not only that of sending electronic messages but also of receiving such. Thereby, system 214 can check internally when an e-mail by recipient 212 to sender 210 was received last and on the basis of that information determine the probability of availability as described above.

It is also possible that the generating module and the input module are combined in one module.

Illustrated in FIG. 4 is a system 314 for determining a preferred communication channel for the delivery of an electronic message to a recipient 312, which, by comparison with system 14 in FIG. 1, includes an additional configuration module 320 and a status module 321, both of which exchange information with an interface module 317.

With configuration module 320, the recipient 312 can define for which communication channel a probability of availability should be estimated and/or which requesting systems can make a request for a preferred communication channel and/or for what sender requesting systems can make a said request for a preferred communication channel and/or how the preferred communication channel should be determined from the individual probabilities of availability of the different communication channels. In this manner, recipient 312 can adapt the behavior of system 314 to their needs.

With status module 321, recipient 312 can define, in one or several communication channels, several statuses characteristic of them, which, via interface module 317, are transmitted to the different communication channels and therefore are also transmitted to the sender. A status contains information about the whereabouts of the recipient, their current activity. Another status contains information on the emotional state of the recipient such as, for example, “I am tired”, “I am happy”. Such further information can either be input by the recipient or generated automatically.

What is claimed is:

1. System for determining a preferred communication channel from a plurality of possible communication channels for delivery of an electronic message from a sender to a recipient comprising:
an input module, for receiving a request from a requesting system for a determination of the preferred communication channel from the sender to the recipient,
an interface module, comprising at least a first interface to a first communication channel and a second interface to a second communication channel of the plurality of possible communication channels to the recipient, and
a selection module,
for determining at least a first probability of availability of the recipient of the electronic message via the first communication channel and a second probability of availability of the recipient of the electronic message via the second communication channel, and
for provisionally determining the preferred communication channel depending on the first and second probability of availability of the recipient of the electronic message,
the selection module for further taking into account a confidentiality level characterizing the degree of confidentiality desired of the electronic message for determining the preferred communication channel.

2. System as claimed in claim 1, wherein the selection module further for estimating the probability of availability of the recipient via each of the plurality of communication channels depending on a time duration since the last use of that respective communication channel by the recipient.

3. System as claimed in claim 1, wherein the selection module is further for polling an activity status of the recipient on each of the plurality of communication channels to estimate the probability of availability of the recipient via that respective communication channel depending on the polled activity status for that respective communication channel.

4. System as claimed in claim 3, wherein the selection module further for estimating the probability of availability of the recipient via each of the plurality of communication channels depending on a change in the activity status of the recipient on that respective communication channel.

5. System as claimed in claim 1, further comprising a transmitter module as a component of the interface module, the transmitter module for sending the electronic message via the preferred communication channel to the recipient, the input module for accepting also the content of the electronic message

6. System as claimed in claim 5, further comprising a generating module for generating an electronic message.

7. System as claimed in claim 1, further comprising a configuration module for defining by the recipient at least one of the following:
for which of the plurality of communication channels a probability of availability shall be estimated,
which of the requesting systems can make a request for a preferred communication channel,
for what sender requesting systems can make a request for a preferred communication channel,
how the preferred communication channel shall be determined from the individual probabilities of availability of each of the plurality of communication channels.

8. System as claimed in claim 1, further comprising
a status module, for defining by the recipient a status characteristic of the recipient, that can be transmitted to the sender.

9. Method for determining a preferred communication channel from a plurality of possible communication channels for delivery of an electronic message from a sender to a recipient via a system comprising an input module for receiving a request for a preferred communication channel, a selection module for determining the preferred communication channel and an interface module comprising at least a first interface to a first communication channel and a second interface to a second communication channel of the plurality of possible communication channels to recipient, said method including the following steps:
a request for a preferred communication channel to recipient is received via the input module,
then the selection module estimates a first probability of availability of recipient of the electronic message via the first communication channel and a second probability of availability via the second communication channel and thereupon provisionally determines the preferred communication channel depending on the first and second probability of availability, and
then the selection module, in determining the preferred communication channel, takes into consideration a confidentiality level characterizing the confidentiality of the electronic message.
